(19) United States
(12) Patent Application Publication
(10) Pub. No.: US 2012/0292133 A1
(43) Pub. Date: Nov. 22, 2012

(54) Zero-Carbon Clean Energy Generator and Operating Method Thereof

(76) Inventor: Huang-Hsing Hu, Taichung City (TW)

(21) Appl. No.: 13/108,037

(22) Filed: May 16, 2011

(51) Int. Cl. F03G 3/06; F03G 7/10

(52) U.S. Cl. 185/29; 74/DIG. 9

(57) ABSTRACT

A zero-carbon clean generator has a rotating rod, multiple swings, a sleeve and multiple pendulums. The rotating rod acts as a spindle pole and a fulcrum. The swings are mounted around the rotating rod and each swing has a structure of two flywheels to rotate clockwise and counter-clockwise. The sleeve is connected with the rotating rod. The pendulums respectively are connected with the swings and the sleeve. Each pendulum has an inner space filled with fluid. Accordingly, the pendulums are swung back and forth reciprocatingly, make the rotating rod rotate continuously in a fixed direction and eternally generate power.

### BACKGROUND OF THE INVENTION

1. Field of the Invention

The present invention relates to a generator, and more particularly to a zero-carbon clean energy generator for eternally generating employable power.

2. Description of Related Art

Energy demand of mankind is ever increasing. Limited resources on the Earth have been almost exhausted due to the greed of humans, and the environment is vulnerable and is difficult to recover. The damages to the environment are as follows, oil depletion, the greenhouse effect, species extinction, and extreme climate changes at North and South poles and other consequences.

Nowadays, many governments, research groups or companies realize the seriousness of environmental damage and are eager to find solutions, hoping to delay or eliminate the destruction of the Earth's environment. The solutions comprise: reducing pollution, reducing energy consumption or developing alternative energy, such as biofuel, geothermal power or hydropower, nuclear energy, wind energy and solar energy.

However, these innovative and alternative solutions have different limitations or pollution and waste disposal issues. “Biofuel” encounters food supply and humanitarian issues. “Geothermal energy or hydropower” requires areas with specific environmental and geographical characteristics. “Nuclear energy” has radiation pollution and waste disposal problems. The “wind energy” and “solar energy” have to meet many restrictions before they can produce economic benefits. The restrictions comprise climatic, environmental, spatial and other factors. “Solar energy” needs a spacious location with plenty of sunlight supplies. “Wind energy” requires a large area with windy seasons. To overcome the shortcomings, the present invention tends to provide a zero-carbon clean energy generator to mitigate the aforementioned problems. A zero-carbon clean energy generator in accordance with the present invention is groundbreaking and is not relevant to any prior art.

### SUMMARY OF THE INVENTION

The main objective of the invention is to provide a zero-carbon clean energy generator that can eternally generate employable power. The zero-carbon clean energy generator exerts gravity to oscillate under its own inertia and to act as a pendulum, changes its center-of-gravity position by means of essential mechanical design and fluid prone to a balanced position and operates continuously to eternally generate employable power. The present invention is not restricted by sunlight, environment or climate and can always operate as long as the gravity exists.

A zero-carbon clean generator has a rotating rod, multiple swings, a sleeve and multiple pendulums. The rotating rod acts as a spindle pole and a fulcrum. The swings are mounted around the rotating rod and each swing has a structure of two flywheels to rotate clockwise and counter-clockwise. The sleeve is connected with the rotating rod. The pendulums respectively are connected with the swings and the sleeve. Each pendulum has an inner space filled with fluid. Accordingly, the pendulums are swung back and forth reciprocatingly, make the rotating rod rotate continuously in a fixed direction and eternally generate power.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a zero-carbon clean energy generator in accordance with the present invention;

FIG. 2 is an exploded perspective view of the zero-carbon clean energy generator in FIG. 1;

FIG. 3 is a side view of the zero-carbon clean energy generator in FIG. 1;

FIG. 4 is a cross sectional view of the zero-carbon clean energy generator in FIG. 1;

FIG. 5 is an enlarged side view in partial section of a sleeve of the zero-carbon clean energy generator in FIG. 1;

FIG. 6 is a side view of a swing of the zero-carbon clean energy generator in FIG. 1;

FIG. 7 is a cross-sectional view of the zero-carbon clean energy generator along the line 7-7 in FIG. 6;

FIG. 8 is a cross-sectional view of the zero-carbon clean energy generator along the line 8-8 in FIG. 6;

FIG. 9 is a perspective view of the zero-carbon clean energy generator in FIG. 1, wherein the pendulums are located at the same latitudinal plane;

FIG. 10 is a side view of the zero-carbon clean energy generator in FIG. 9;

FIG. 11 is an operational side view of the zero-carbon clean energy generator in FIG. 10, wherein the pendulum A swings to a swing angle θ1;

FIG. 12 is a perspective view of the zero-carbon clean energy generator in FIG. 11;

FIG. 13 is an operational side view of the zero-carbon clean energy generator in FIG. 10, wherein the pendulum A swings to the swing angle θ2 and the pendulum B swings to the swing angle θ1;

FIG. 14 is a perspective view of the zero-carbon clean energy generator in FIG. 13;

FIG. 15 is an operational side view of the zero-carbon clean energy generator in FIG. 10, wherein the pendulum A swings to the swing angle θ3 and the pendulum C swings to the swing angle θ1;

FIG. 16 is a top view of the zero-carbon clean energy generator in FIG. 15;

FIG. 17 is a side view in partial section of the zero-carbon clean energy generator in FIG. 1, showing a tenon is acutated;

FIG. 18 is a top view of the zero-carbon clean energy generator in FIG. 17;

FIG. 19 is an operational side view of the zero-carbon clean energy generator in FIG. 10, wherein the pendulum A swings back to the swing angle θ2 and the pendulum D swings to the swing angle θ1;

FIG. 20 is a top view of the zero-carbon clean energy generator in FIG. 19;

FIG. 21 is an operational side view of the zero-carbon clean energy generator in FIG. 10, wherein the pendulum A swings back to the swing angle θ1 and the pendulum E swings to the swing angle θ1;

FIG. 22 is a top view of the zero-carbon clean energy generator in FIG. 21;

FIG. 23 is an operational side view of the zero-carbon clean energy generator in FIG. 10, wherein the pendulum A swings back to the swing angle θ0 and the pendulum F swings to the swing angle θ1;

FIG. 24 is a top view of the zero-carbon clean energy generator in FIG. 23;

FIG. 25 is a perspective view of a standing tenon of the zero-carbon clean energy generator in accordance with the present invention in FIG. 1;

FIG. 26 is a perspective view of another tenon of the zero-carbon clean energy generator in accordance with the present invention in FIG. 1;

FIG. 27 is a perspective view of another tenon of the zero-carbon clean energy generator in accordance with the present invention in FIG. 1;

FIG. 28 is a perspective view of a retractable protruding gear of the zero-carbon clean energy generator in accordance with the present invention in FIG. 1; and

FIG. 29 is a perspective view of a movable retractable concave gear of the zero-carbon clean energy generator in accordance with the present invention in FIG. 1.

### DETAILED DESCRIPTION OF PREFERRED EMBODIMENT

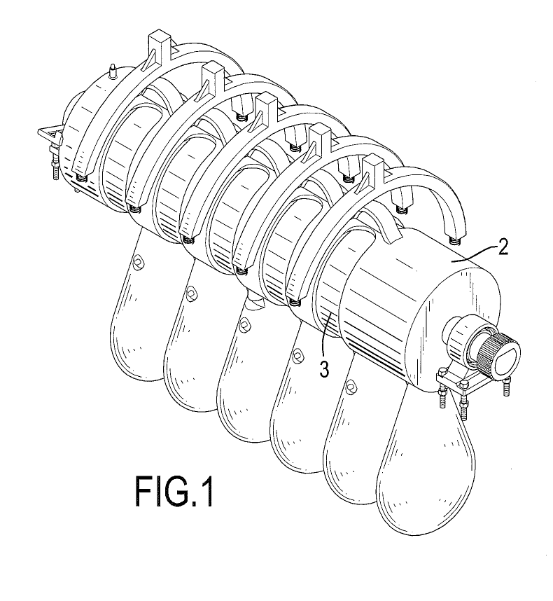

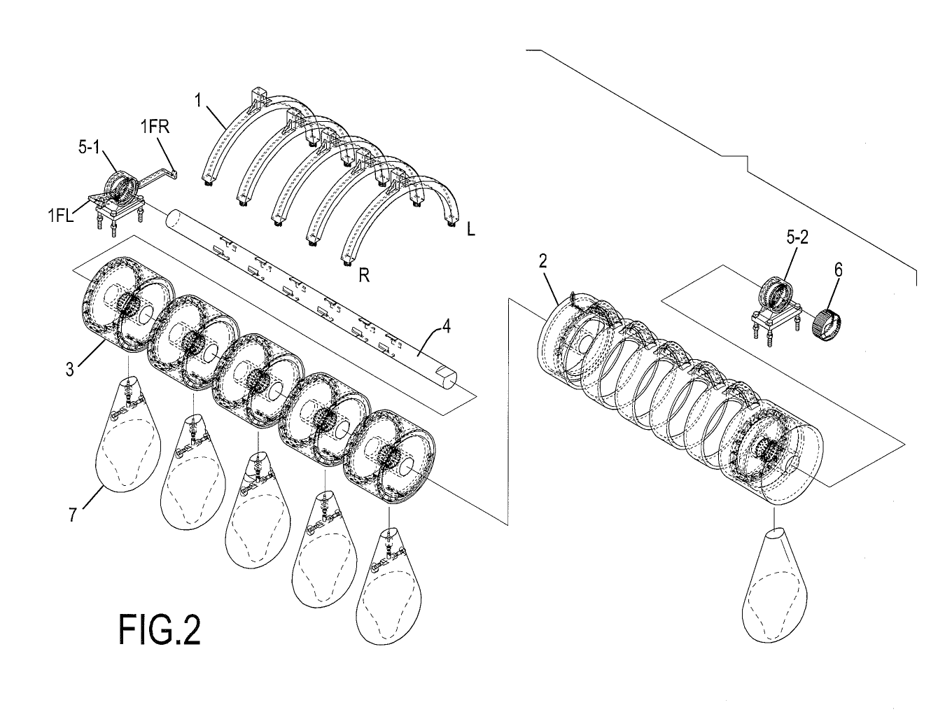

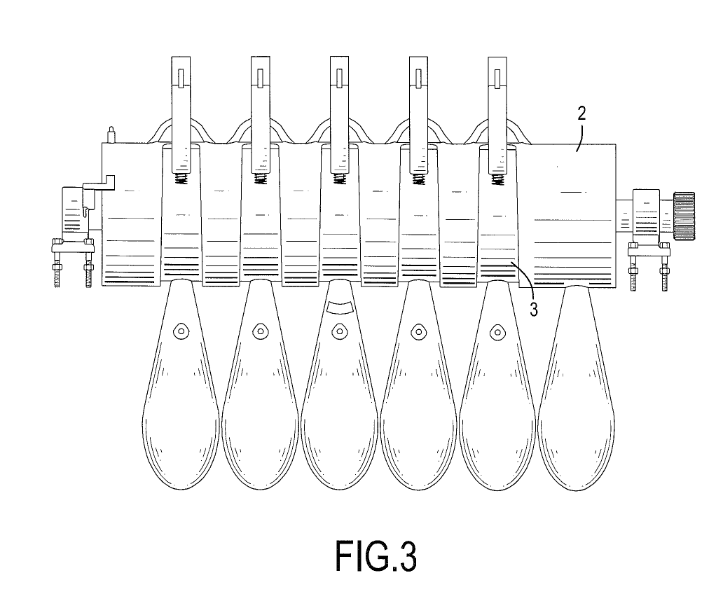

With reference to FIGS. 1 to 3, a zero-carbon clean energy generator in accordance with the present invention exerts gravity to oscillate under its own inertia and to act as a pendulum, changes its center-of-gravity position by means of essential mechanical design and fluid prone to a balanced position, makes a descending force arm greater than an ascending force arm, makes a descending work greater than an ascending work to make the mechanical efficiency greater than 1, and operates continuously to eternally generate employable power.

The zero-carbon clean energy generator has a rotating rod, multiple swings, a sleeve and multiple pendulums. The rotating rod acts as a spindle pole and a fulcrum. The swings are mounted around the rotating rod and each swing has a structure of two flywheels to rotate clockwise and counter-clockwise. The sleeve is connected with the rotating rod. The pendulums respectively are connected with the swings and the sleeve. Each pendulum has an inner space filled with fluid. Accordingly, the pendulums are swung back and forth reciprocatingly to make the rotating rod rotate continuously in a fixed direction and eternally generate power.

A swinging object (such as a pendulum) is subject to turn still when the object swings on a fixed force arm without any eternal force applied. When the object and a fulcrum are located at the same latitudinal plane (assuming a swing angle between the object and the latitudinal plane is 0°), the object begins to swing and then gradually turns still.

The swing angle between the highest point that the object may reach and the longitudinal plane has to be less than 172°. The maximum swing angle depends on an angle between the swing axis of the object and the outer edge of the object.

Preferably, the pendulums swing to enable the fluid filled in the inner spaces in the pendulums to flow. Accordingly, the positions of the gravity centers of the pendulums change and the force arms of the pendulums also change (large force and small resistance). Consequently, the mechanical efficiency of the zero-carbon clean energy generator is more than 1 because the pendulums act alternately to make each pendulum return to its initial position (the swing angle is 0°).

Swinging the Pendulums Clockwise:

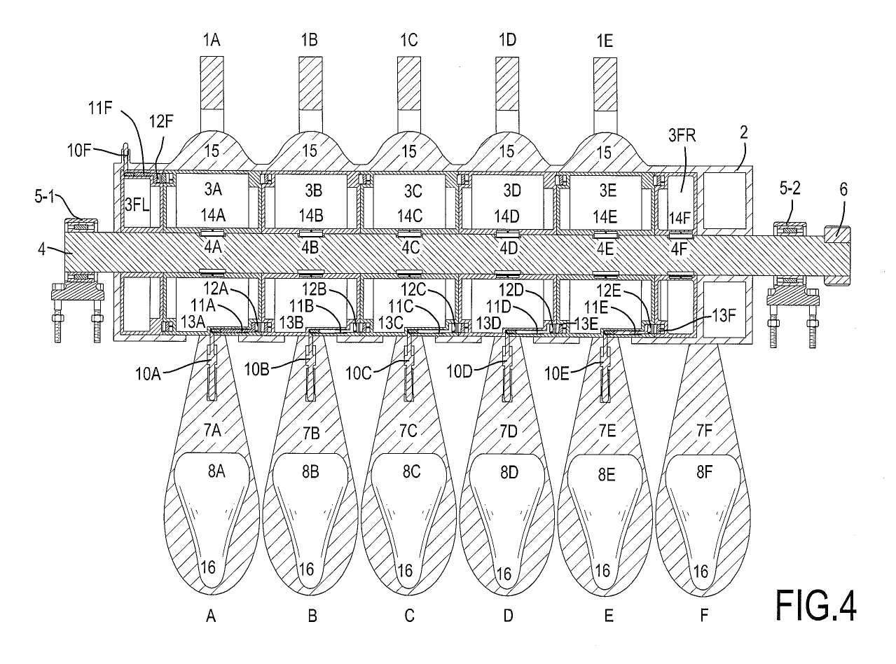

With further reference to FIG. 4, the multiple pendulums A, B, C, D, E, F are placed on the same side of the rotating rod. Multiple angle-sensing controllers and pneumatic actuators can actuate the pendulums to make the rotating rod and the pendulums located at the same latitudinal plane (that is, the swing angle is zero).

Each pendulum has a triangular inner space filled with fluid or rollable balls. Preferably, the fluid is non-corrosive mercury. The mercury is still and is located at a lowest position adjacent to the rotating rod O. The gravity center of each pendulum is approximately located at a point Xr. The force arm is the segment OXr and the force is zero.

Step 1:

When the pendulum A begins to swing, the swing angle changes and the mercury flows toward the lowest position relative to the inner space of the pendulum. Accordingly, the gravity center of the pendulum A changes from the point Xr to a point Yr. The force arm extends to a segment OYr and a torque increases. Because the force arm OYr of the swing angle θ1 (60°) is larger than the force arm OXr, an accelerated and additive effect is continuously applied to the pendulum until the swing angle is 90°.

Step 2:

When the pendulum begins to swing, the swing begins to rotate clockwise. The protruding gear having a flywheel function begins to engage a fixed concave gear of the rotating rod. Consequently, the rotating rod begins to rotate in a fixed direction and to generate employable energy, such as electricity. When the swing angle is 90°, the pendulum starts to move upwardly and slows down gradually because of gravity and potential differences.

Step 3:

The fluid continues to flow as the pendulum swings. Accordingly, the gravity center of the pendulum A changes from a point Yt to a point Xt. The force arm is shortened from a segment OYt to a segment OXt. Similarly, a counter force arm is also shortened from the segment OYt to the segment OXt. The counter force is reduced.

Preferably, the zero-carbon clean energy generator in accordance with the present invention has six pendulums. When the pendulum A swings to the swing angle θ1, a pendulum B is actuated to swing by an angle-sensing controller. Similarly, when the pendulum B swings to the swing angle θ1, a pendulum C is actuated to swing by an angle-sensing controller and so on.

When the pendulum A passes the swing angle of 90°, the pendulum A starts to move upwardly, slows down gradually because of gravity and potential differences and slows down the swing. However, the rotating rod does not slow down because the pendulum B swings downwardly and the swing engages the pendulum B. When a speed of the clockwise ascending pendulum A is slower than that of the clockwise descending pendulum B, the retractable protruding gear of the pendulum A does not engage the fixed concave gear of the rotating rod.

Preferably, the maximum angle between each swing and each pendulum is set as an angle of 172°. Multiple tenon actuators are respectively mounted above the pendulums to actuate the fixed concave gears. When the pendulum A passes the swing angle of 90°, the pendulum A starts to move upwardly and slows down gradually because of gravity and potential differences. Consequently, a counter force is generated. When an ascending force is equal to the descending counter force, the pendulum A swings to its maximum clockwise angle, which is θ3. The pendulum A begins to swing back at the swing angle θ3. The edge of the pendulum A is approximately located at the swing angle θ of 172°.

Step 4:

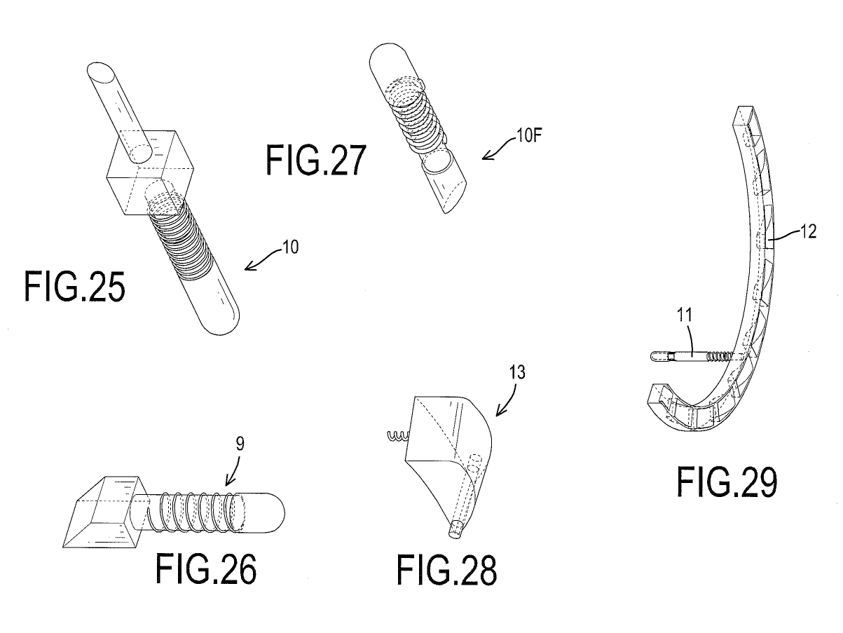

With reference to FIGS. 25 to 29, a tenon hits one of the tenon actuator. Therefore, the tenon at left side of the pendulum A is pushed. A standing tenon is also pushed to actuate a retractable tenon and to push a fixed concave gear. The fixed concave gear at a right side of the swing engages the retractable protruding gear.

Swinging the Pendulums Counterclockwise:

When the pendulum A swings back counterclockwise, the mercury flows back as in Step 1. An accelerated and additive effect is continuously applied to the pendulum A until the swing angle is 90°. After passing the swing angle of 90°, the pendulum A swings counterclockwise to ascend. Consequently, a counter force is generated because of gravity and potential difference. The counter force increases as the pendulum A swings back to its initial position and slows down. The mercury in the pendulum A flows as in Step 2. When a speed of the ascending pendulum A is slower than that of the descending pendulum B, Step 5 is proceeded.

Step 5:

Gears having a flywheel function of the pendulum A and the pendulum B engage each other. Therefore, the pendulum B accelerating downwardly drives the pendulum A to slow down upwardly. Because the force arm (B) OYt is larger than the force arm (A) OXr, a swinging speed varies as the pendulum B swings downwardly and the pendulum A swings upwardly. The gears separate when the pendulum A returns to its initial position.

Step 6:

When the pendulum A swings counterclockwise and is close to its initial position, the tenon located at the right side of the pendulum A touches the tenon actuator. A retractable tenon is also pushed again to retract a retractable tenon and to push a fixed concave gear. The fixed concave gear at a right side of the swing engages the retractable protruding gear. The pendulum A and the pendulum B disengage from each other to stop a flywheel function. A swing cycle of the pendulum A is finished. Because of gravity and potential difference, the pendulum A will swing clockwise again to start a next swinging cycle.

Preferably, steps of the swinging cycle of the pendulum comprises actuating pendulums, swinging the pendulums clockwise and swinging the pendulums counterclockwise and proceeding with Step 1, Step 2, Step 3, Step 4, Step 5 and Step 6 continuously.

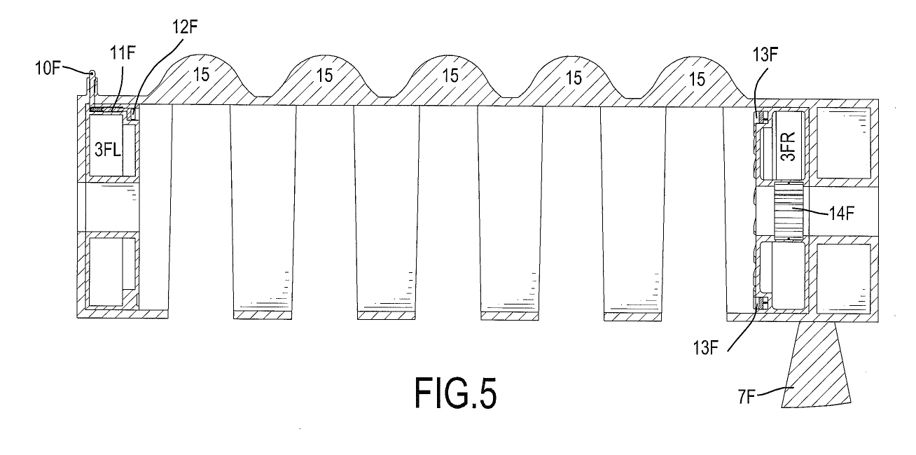

With reference to FIG. 5, preferably, the sleeve is connected with a pendulum and contains the rotating rod and the swings. The sleeve has an inner space. The inner space of the sleeve has a right area, a left area and two half-sided structures 3FL, 3FR respectively located at the right area and the left area of the inner space of the sleeve to drive opposite two of the swings. A maximum swing angle of each pendulum is 172° (degree). The remaining angle is 8° (degree) so that the sleeve is supported. Accordingly, a supporting angle 15 is strengthened (15 refers to a reference number, instead of degree of an angle). The remaining angle can also facilitate the rotation of the rotating rod. A standing tenon is mounted above a left side of the rotating rod to actuate the movement of the retractable fixed concave gear.

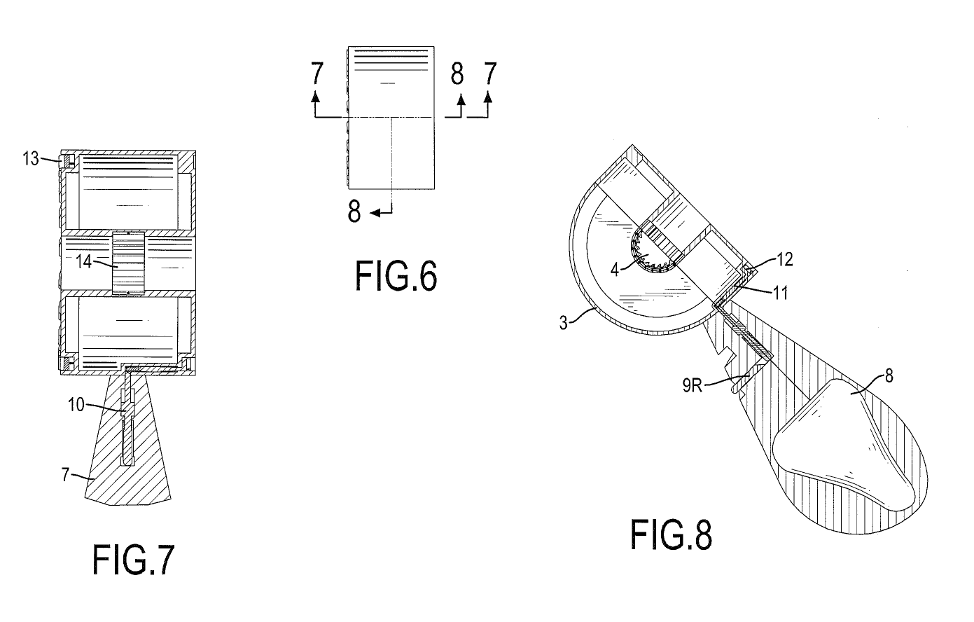

With reference to FIGS. 4 to 8, the rotating rod 4 is used as a spindle pole and a fulcrum and is connected with five swings. Five pendulums 7A,7B,7C,7D,7E are respectively connected with the swings 3A,3B,3C,3D,3E. The sleeve 2 is connected with the rotating rod 4 and has an inner space. The inner space of the sleeve has a right area, a left area and two half-sided structures 3FL, 3FR respectively located at the right area and the left area of the inner space of the sleeve 2. The sleeve 2 is put on two brackets 5-1, 5-2 and is connected with a pendulum 3F. The six pendulums 7A,7B,7C,7D,7E,7F are placed at a right side of the rotating rod 4 and are placed at the same latitudinal plane.

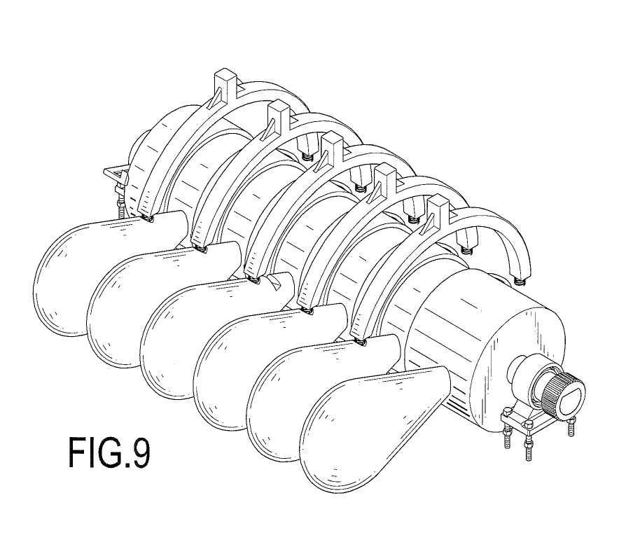

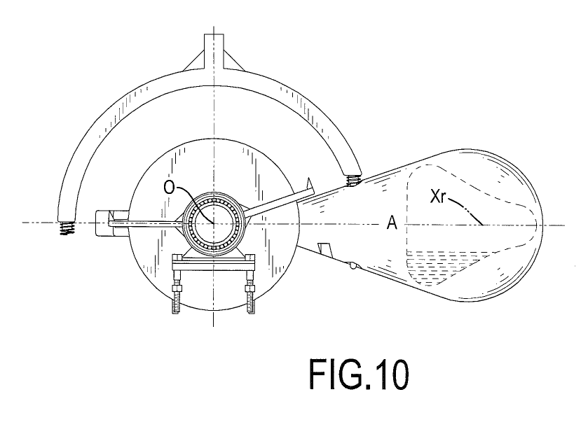

With reference to FIGS. 9 and 10, an angle between an axis of each pendulum and the rotating rod 4 is θ⁰ (θ⁰=0). The mercury in the inner spaces 8A,8B,8C,8D,8E,8F are at the lowest positions and are close to the rotating rod. Multiple tenon actuators 1A,1B,1C,1D,1E,1F are respectively mounted above the pendulums A,B,C,D,E,F to actuate the fixed concave gears 12A,12B,12C,12D,12E,12F. Therefore, a gravity center of each pendulum is located a point Xr. Each force arm is the distance between each gravity center and an axis of the rotating rod. When the pendulum 7A begins to swing, a clockwise force is generated and the mercury 16 flows toward the lowest position relative to the inner space 8A of the pendulum. Step 1 begins.

Accordingly, the gravity center of the pendulum A changes. Meanwhile, a fixed concave gear 4A is engaged with a retractable gear 14A to rotate the rotating rod 4. The rotation of the rotating rod 4 speeds up as the pendulum swings clockwise. A flywheel function of the swing 3 is applied to the rotating rod 4, and step 2 begins.

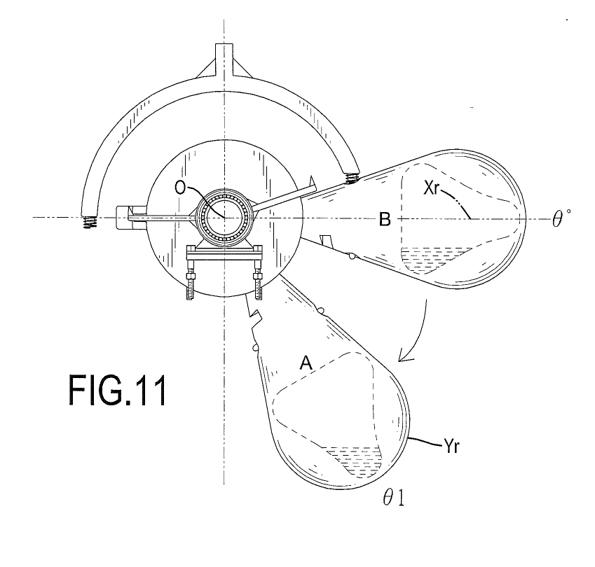

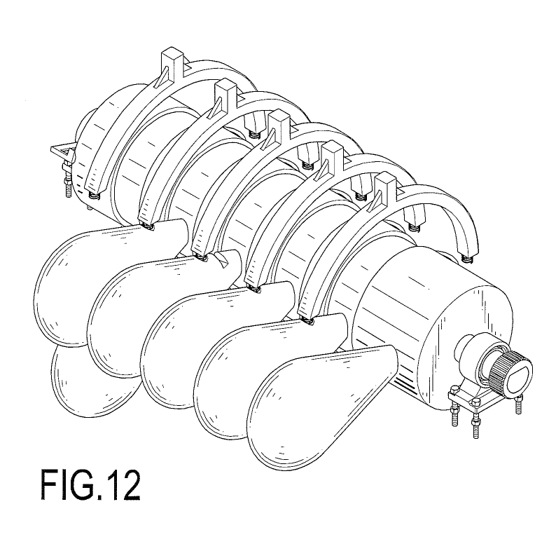

With reference to FIGS. 11 to 12, when the pendulum 7A swings clockwise to an angle θ1 of 60°, the pendulum 7B is actuated by an angle-sensing actuator and begins to swing clockwise, and a clockwise force Fb is generated. Meanwhile, the pendulum 7B proceeds with steps 1 and 2. When the pendulum 7A swings to the swing angle of 90°, the speed of the pendulum 7A is a maximum speed.

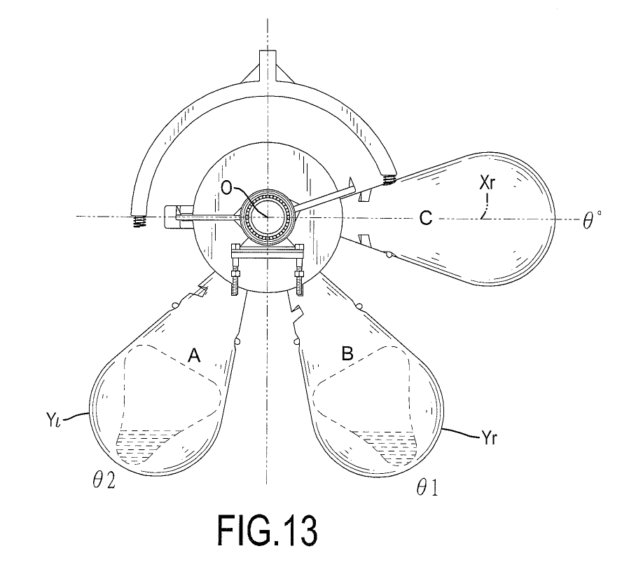

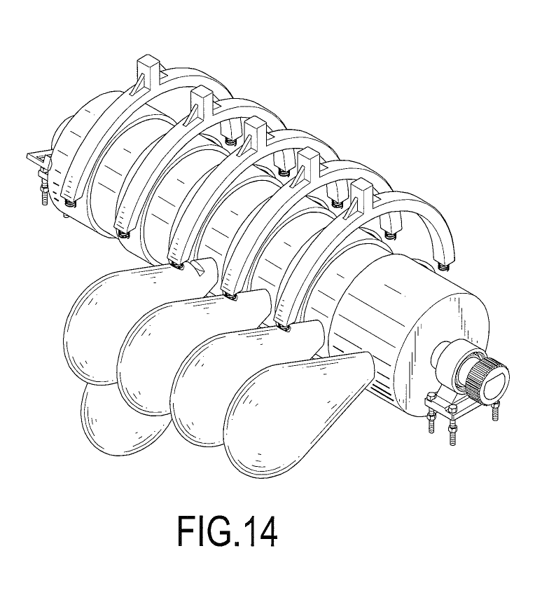

With reference to FIGS. 13 to 14, when the pendulum 7B swings clockwise to an angle θ1 of 60°, the pendulum 7C is actuated by an angle-sensing actuator and begins to swing clockwise, and a clockwise force Fc is generated. Meanwhile, the pendulum 7C proceeds with steps 1 and 2. When the pendulum 7A swings to the swing angle θ2 of 120°, step 3 begins. The gravity center of the pendulum 7A changes. When the swing angle is 90°, the pendulum 7A starts to move upwardly and slows down gradually because of gravity and potential differences. The rotating speed of the rotating rod 4 slows down because the swing 3B engages the rotating rod 4.

When a speed of the clockwise ascending pendulum 7A is slower than that of the clockwise descending pendulum 7B, the retractable protruding gear 14A of the pendulum 7A does not engage the rotating rod 4. When the pendulum 7B swings to the swing angle of 90°, the speed of the pendulum 7B is a maximum speed.

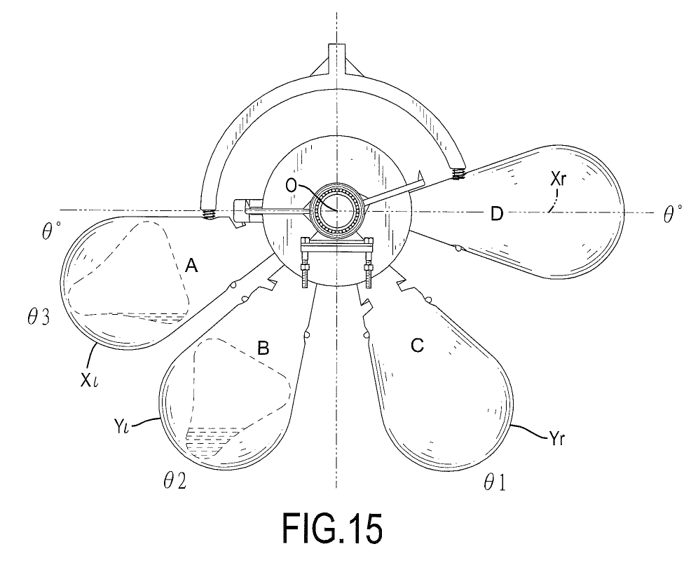

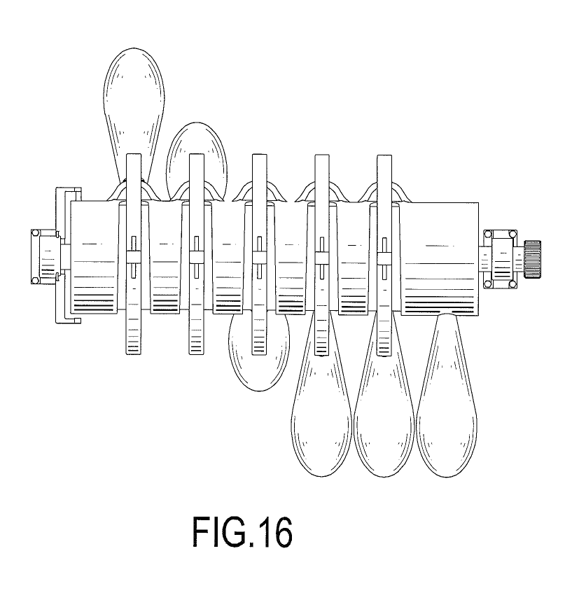

With reference to FIGS. 15 to 16, when the pendulum 7C swings clockwise to an angle θ1 of 60°, the pendulum 7D is actuated by an angle-sensing actuator and begins to swing clockwise. A clockwise force Fd is generated. Meanwhile, the pendulum 7D proceeds with steps 1 and 2. When the pendulum 7B swings to the swing angle θ2 of 120°, step 3 begins. The gravity center of the pendulum 7D changes. When the swing angle is 90°, the pendulum 7B starts to move upwardly and slows down gradually because of gravity and potential differences. The rotating speed of the rotating rod 4 slows down because the swing 3C engages the rotating rod 4. When a speed of the clockwise ascending pendulum 7B is slower than that of the clockwise descending pendulum 7C, the retractable protruding gear 14B of the pendulum 7B does not engage the rotating rod 4. When the pendulum 7C swings to the swing angle of 90°, the speed of the pendulum 7C is a maximum speed.

When a weakening clockwise force of the pendulum 7A is equal to an increasing counterclockwise force, the pendulum 7A does not drive the swing 3A to rotate. The pendulum 7A swings to its maximum clockwise angle, which is θ3. The pendulum A begins to swing back at the swing angle θ3. The edge of the pendulum A is approximately located at the swing angle θ of 162°.

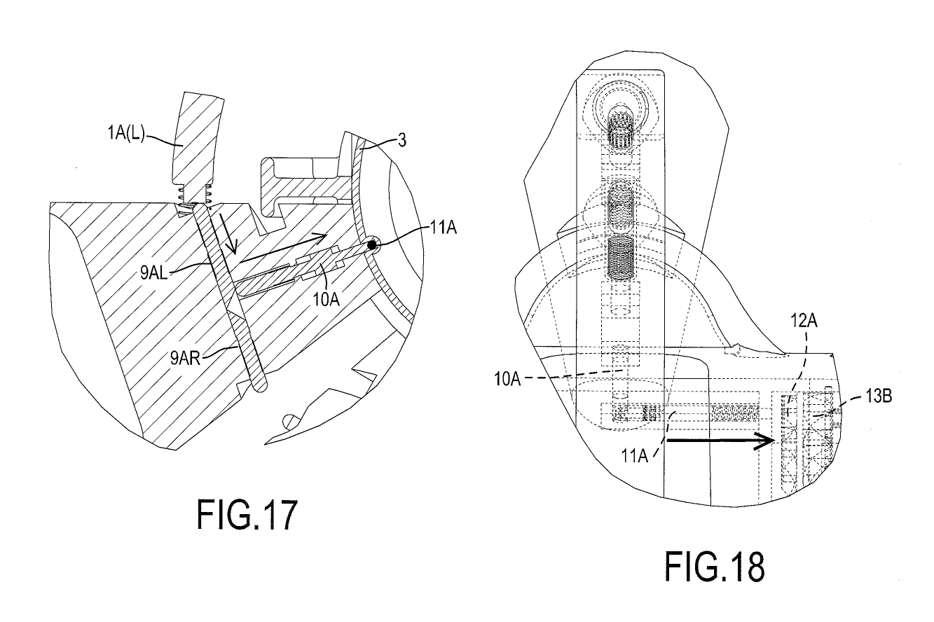

Therefore, the tenon 9AL at left side of the pendulum is pushed. A standing tenon 10A is also pushed to actuate a retractable tenon 11A and to push a movable fixed concave gear 12A. With reference to FIGS. 17 to 18, step 4 begins. The tenon 9A1 hits the standing tenon 10A. The standing tenon actuates the retractable tenon 11A to push the movable fixed concave gear 12A. A complete course of the clockwise movement of the pendulum A is finished. This is also the initial position from which the counterclockwise movement starts. A counterclockwise force Fa is generated. The mercury 16 in the inner space 8A flows back as in step 1. The accelerated and additive effect is continuously applied to the pendulum until the swing angle is 90°.

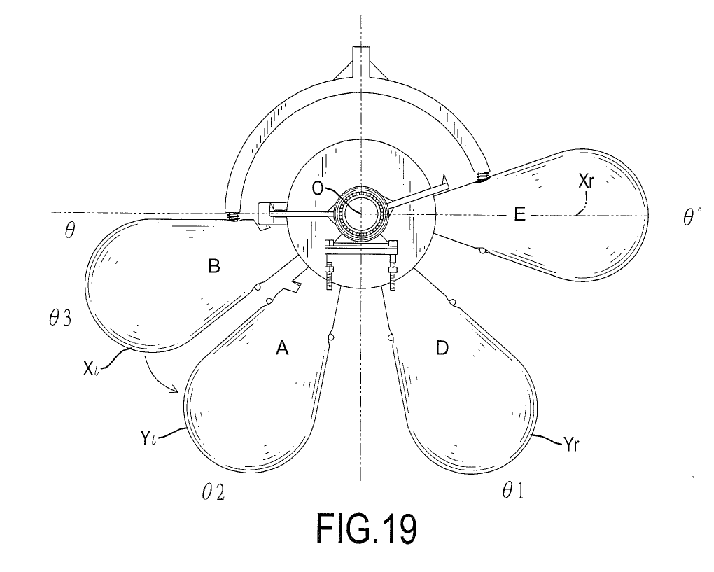

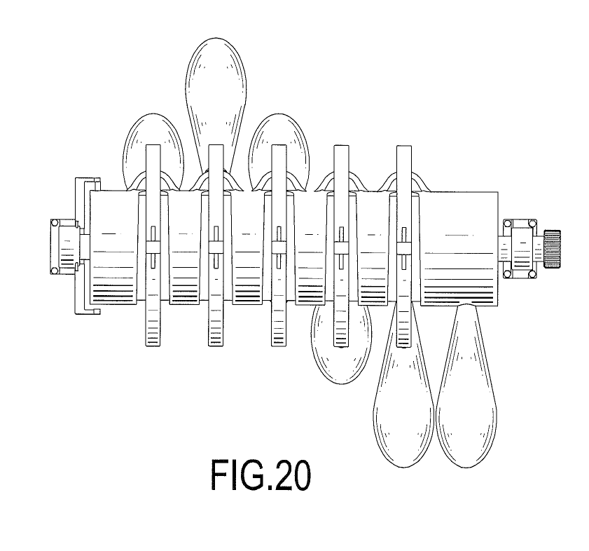

With reference to FIGS. 19 to 20, when the pendulum 7D swings clockwise to an angle θ1 of 60°, the pendulum 7E is actuated by an angle-sensing actuator and begins to swing clockwise and to rotate the rotating rod 4 continuously. The pendulums 7B,7C also swing respectively to the swing angles θ2 and θ3. The procedure is the same as that of the pendulum 7A and detailed description is omitted. Meanwhile, the position of the pendulum 7A is approximately the same as that of the pendulum 7C, but the directions of the pendulums 7A,7C are different. When a speed of the pendulum 7A at the swing angle θ2 is higher than that of the pendulum 7B, the retractable protruding gear 13B of the pendulum 7B does not engage the moveable fixed concave gear 12A.

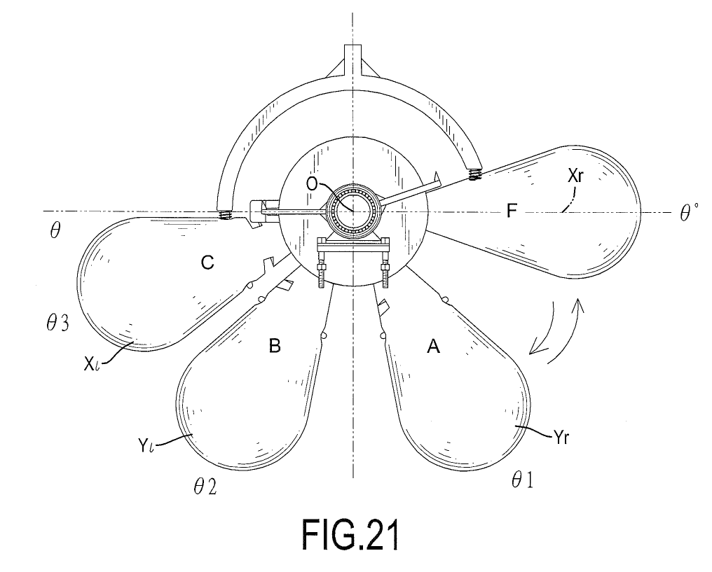

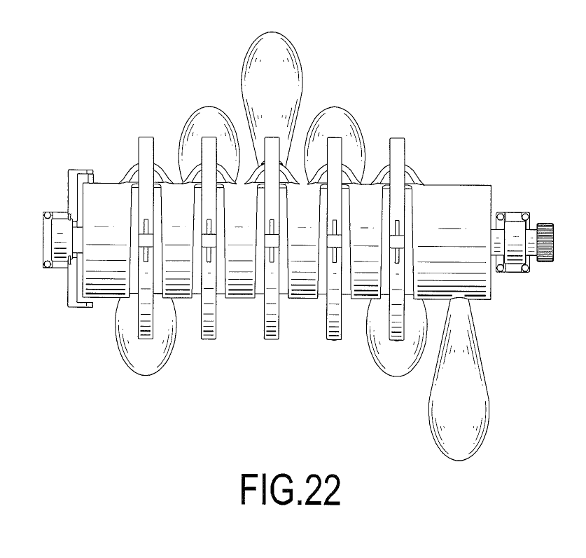

With reference to FIGS. 21 to 22, when the pendulum 7E swings clockwise to an angle θ1 of 60°, the pendulum 7F is actuated by an angle-sensing actuator and begins to swing clockwise. The pendulum 7F drives the sleeve 2 to rotate because the pendulum 7F is connected with the sleeve 2.

The standing tenon 10F located above the sleeve 2 disconnects from the tenon actuator 1FR located at the left-sided bracket 5-1. The rotating rod 4 is continuously driven to rotate clockwise. The pendulums 7C,7D also swing respectively to the swing angles θ2 and θ3. Meanwhile, the position of the pendulum 7B is approximately the same as that of the pendulum 7D, but the directions of the pendulums 7B,7D are different. The procedure is the same as that with the pendulum 7A and detailed description is omitted.

Meanwhile, the position of the pendulum 7A is approximately the same as that of the pendulum 7E, but the directions of the pendulums 7A,7E are different.

When the swing angle is 90°, the pendulum 7A starts to move upwardly and slows down gradually because of gravity and potential differences. The rotating speed of the rotating rod 4 slows down because the swing 3C engages the rotating rod 4. The counter force increases as the pendulum swings back to its initial position and slows down the pendulum. The mercury in the pendulum flows as in Step 2. When a speed of the ascending pendulum A is slower than that of the descending pendulum B, a force arm is shortened.

When a speed of the ascending pendulum 7A is slower than that of the descending pendulum 7B, the retractable protruding gears of the swings 3A,3B proceed with step 5. A force arm (7B) OYι is larger than (7A) OXr until the pendulum 7A returns to its initial position at θ.

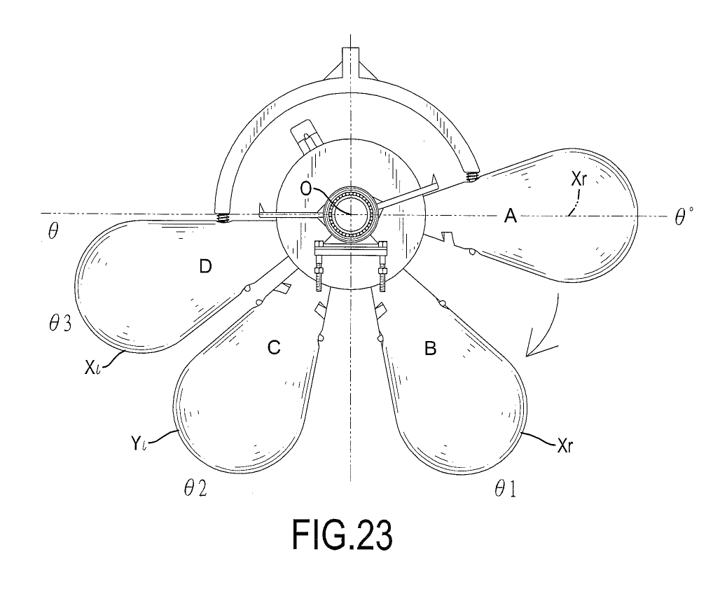

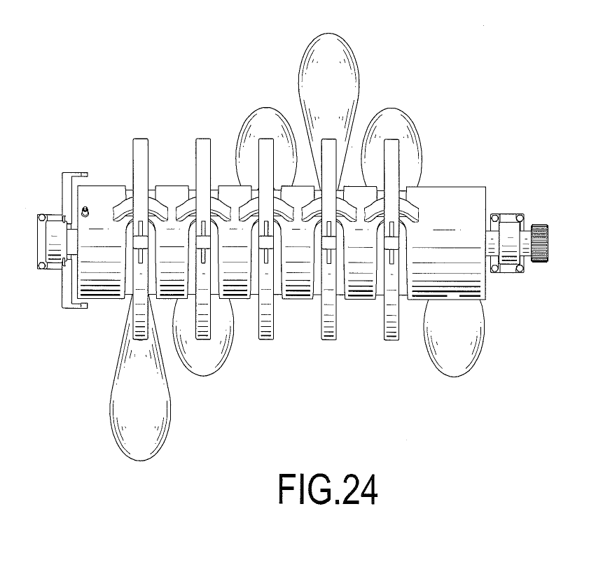

With reference to FIGS. 23 to 24, when the pendulum 7F swings to the swing angle θ1 of 60°, the pendulums 7B,7C return respectively to positions at θ2, θ3. The movements are the same as that of the pendulum 7A and detailed description is omitted. Meanwhile, the pendulum 7A is driven by the pendulum 7B to return to the initial position at θ0. When the pendulum 7A is close to the initial position at θ0, step 6 is proceeded and the movable fixed concave gear 12A disengage from the pendulum 7B. The pendulums 7A,7B temporarily do not act. A cycle of the swing movement of the pendulum A is finished. Because of gravity and potential difference, the pendulum A will swing clockwise again to start a next swinging cycle. A clockwise force Fa is generated. The movements of the pendulums B,C,D,E,F are the same as that of the pendulum A and detailed description is omitted.

However, the left-sided standing tenon 10F is actuated by the tenon actuator 1F to control the movable fixed concave gear 12F. The sleeve 2 enables the opposite two pendulums A,F to move. Accordingly, the pendulums can always swing to rotate the rotating rod 4 eternally.

From the above description, it is noted that the present invention has the following advantages:

The zero-carbon clean energy generator in accordance with the present invention exerts gravity to oscillate under its own inertia and to act as a pendulum, changes its center-of-gravity position by means of essential mechanical design and fluid prone to a balanced position, makes a descending force arm greater than an ascending force arm, makes a descending work greater than an ascending work to make the mechanical efficiency more than 1, and operates continuously to eternally generate employable power. The present invention is not restricted by sunlight, environment or climate and can always operate as long as the gravity exists.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A zero-carbon clean energy generator, which exerts gravity to oscillate under its own inertia and to act as a pendulum, changes its center-of-gravity position by means of essential mechanical design and fluid prone to a balanced position, makes a descending force arm greater than an ascending force arm, makes a descending work greater than an ascending work to make the mechanical efficiency more than 1, and operates continuously to eternally generate employable power, the zero-carbon clean generator comprising:
a rotating rod as a spindle pole and a fulcrum;
multiple swings mounted around the rotating rod and each swing having a structure of two flywheels to rotate clockwise and counter-clockwise;
a sleeve connected with the rotating rod; and
multiple pendulums respectively connected with the swings and the sleeve, each pendulum having an inner space filled with fluid, wherein the pendulums are swung back and forth reciprocatingly, make the rotating rod rotate continuously in a fixed direction and eternally generate power.

2. The zero-carbon clean energy generator as claimed in claim 1, wherein the rotating rod has multiple movable fixed concave gears and multiple retractable protruding gears; and each swing has a retractable protruding gear being capable of engaging one of the fixed concave gears to drive the rotating rod.

3. The zero-carbon clean energy generator as claimed in claim 1, wherein the amount of the multiple swings is at least two and the swings act with the sleeve cooperatively.

4. The zero-carbon clean energy generator as claimed in claim 1, wherein the sleeve is mounted around the swings and has an inner space; the inner space of the sleeve has a right area, a left area and two half-sided structures respectively located at the right area and the left area of the inner space of the sleeve to drive the opposite two of the swings; a maximum swing angle of each pendulum is 172° (degree); and the remaining angle is 8° (degree) so that the sleeve is supported and the remaining angle is strengthened to facilitate the rotation of the rotating rod.

5. The zero-carbon clean energy generator as claimed in claim 1, wherein the sleeve has a side and a standing tenon mounted above the side of the sleeve to actuate the movable concave gears so that the movable concave gears can be pushed and pulled.

6. The zero-carbon clean energy generator as claimed in claim 1, wherein the outermost angle of each pendulum is formed between a cross point and two opposite sides of each pendulum; the cross point is located between an axis of the rotating rod and a gravity center of each pendulum; and each pendulum is hollow and has the inner space.

7. The zero-carbon clean energy generator as claimed in claim 6, wherein the shape of the inner space of each pendulum is triangular and contains non-corrosive fluid or rollable balls; and the fluid or the balls can change the gravity center of each pendulum and also change each force arm.

8. The zero-carbon clean energy generator as claimed in claim 1, wherein two controlling tenons are respectively mounted securely at two opposite sides of each pendulum; and the controlling tenons can hit tenon actuators to push the standing tenons, to actuate retractable tenons and to control the movable concave gears.

9. The zero-carbon clean energy generator as claimed in claim 1, wherein multiple tenon actuators are respectively formed near the pendulums; and the highest point of a swing range of each pendulum is located at an edge of the pendulum to actuate a pendulum tenon.

10. The zero-carbon clean energy generator as claimed in claim 1, wherein multiple tenon actuators are mounted at a bracket; and the bracket is adjacent to a side of the sleeve and is capable of actuating standing tenons of the rotating rod as the rotating rod rotates.

11. An operating method of a zero-carbon clean generator, which exerts gravity to oscillate under its own inertia and to act as a pendulum and changes its center-of-gravity position by means of essential mechanical design and fluid prone to a balanced position, comprising steps of:
actuating pendulums;
swinging the pendulums clockwise; and
swinging the pendulums counterclockwise.
